(19) United States
(12) Patent Application Publication
(10) Pub. No.: US 2023/0207980 A1
(43) Pub. Date: Jun. 29, 2023

(54) BATTERY

(71) Applicant: TOYOTA JIDOSHA KABUSHIKI KAISHA, Toyota-shi (JP)

(72) Inventor: Ryo KAGAMI, Ichinomiya-shi (JP)

(21) Appl. No.: 18/066,378

(22) Filed: Dec. 15, 2022

(30) Foreign Application Priority Data
Dec. 28, 2021 (JP) 2021-215155

(51) Int. Cl. H01M 50/533

(52) U.S. Cl. CPC H01M 50/533

(57) ABSTRACT

Provided is a battery that can suppress a short circuit that is caused by deformation of a current collector tab. The battery includes: an external body; a power generating element housed in the exterior body; and a filler placed between the power generating element and the exterior body, wherein the power generating element has the current collector tab extending outward, and the current collector tab has at least one depression, at least part of the depression being positioned on an inner side of the current collector tab than a center of a length of the current collector tab in an extending direction.

### FIELD

The present application relates to a battery.

### BACKGROUND

Batteries each formed of an exterior body, a power generating element housed in the exterior body, and a filler placed between the power generating element and the exterior body have been conventionally known. For example, patent literature 1 discloses such a battery.

Patent literature 1 discloses a laminated all-solid-state battery that is formed of an exterior body made of a laminated film and housing: an all-solid-state battery stack that has one or more unit cells each formed by stacking an anode current collector layer having an anode current collector tab, an anode active material layer, a solid electrolyte layer, a cathode active material layer, and a cathode current collector layer having a cathode current collector tab in this order, and that is in contact with the laminated film in the stacking direction; and a filler that is present between the edges of the all-solid-state battery stack in the planar direction. Here, “the edges . . . in the planar direction” in patent literature 1 refer to areas in the vicinities of the anode and cathode current collector tabs. Patent literature 1 discloses that such a laminated all-solid-state battery does not lead to deformation thereof along the edges in the planar direction, and is excellent in battery performance per volume.

### CITATION LIST

### Patent Literature

Patent Literature 1: JP 2018-133175 A

### SUMMARY

### Technical Problem

The inventor of the present disclosure found that there is a problem of deformation of current collector tabs because of low rigidity of the current collector tabs when a filler is poured into the space between a power generating element and an exterior body after the power generating element is housed in the exterior body. The inventor also found that there is a problem of a short circuit that is caused by contact of (a) current collector tab(s) with a counter electrode adjacent to the tab(s) because of the above-described deformation.

In view of the above-described circumstances, an object of the present application is to provide a battery that can suppress a short circuit that is caused by deformation of (a) current collector tab(s).

### Solution to Problem

As one aspect to solve the above-described problems, the present disclosure is provided with a battery comprising: an external body; a power generating element housed in the exterior body; and a filler placed between the power generating element and the exterior body, wherein the power generating element has a current collector tab extending outward, and the current collector tab has at least one depression, at least part of the depression being positioned on an inner side of the current collector tab than a center of a length of the current collector tab in an extending direction.

In the battery, the current collector tab may have a plurality of the depressions; and the plurality of the depressions may be arranged to align in a width direction of the current collector tab. The power generating element may have a plurality of the current collector tabs aligning in a thickness direction, and a position of the depression of one of every adjacent two of the current collector tabs in the thickness direction may be different from a position of the depression of another one of said every adjacent two.

### Advantageous Effects

A current collector tab provided in the battery according to the present disclosure comprises a predetermined depression. The rigidity of the current collector tab is improved because the current collector tab has the depression, which can suppress deformation of the current collector tab which is caused by the filler. Accordingly, the battery according to the present disclosure can suppress a short circuit that is caused by deformation of the current collector tabs.

### BRIEF DESCRIPTION OF DRAWINGS

FIG. 1 is a plan view of a battery 100;

FIG. 2 is a cross-sectional view taken along II-II of FIG. 1;

FIG. 3 is a plan view of a power generating element 10;

FIG. 4 is a cross-sectional view taken along IV-IV of FIG. 3;

FIG. 5 is a plan view focusing on an anode current collector tab 11b of one anode current collector layer 11;

FIG. 6A is a cross-sectional view taken along A-A of FIG. 5, and FIG. 6B is a cross-sectional view taken along B-B of FIG. 5;

FIG. 7 shows one example of a cross-sectional view across the width of the anode current collector tabs 11b stacking in such a way that bottoms 11d of depressions 11c of one of every two adjacent anode current collector tabs 11b in the thickness direction are each entirely included inside depressions 11c of the other one of said every two adjacent anode current collector tabs 11b;

FIG. 8 shows one example of a cross-sectional view across the width of the anode current collector tabs 11b stacking in such a way that the positions of the depressions 11c of one of every two adjacent anode current collector tabs 11b are apart (offset) in the width direction from the positions of the depressions 11c of the other one of said every two adjacent anode current collector tabs 11b;

FIG. 9 shows another example of a cross-sectional view across the width of the anode current collector tabs 11b stacking in such a way that the positions of the depressions 11c of one of every two adjacent anode current collector tabs 11b are apart (offset) in the width direction from the positions of the depressions 11c of the other one of said every two adjacent anode current collector tabs 11b;

FIG. 10 shows an example of a cross-sectional view across the width of the anode current collector tabs 11b stacking in such a way that the positions of the depressions 11c of one of every two adjacent anode current collector tabs 11b are apart (offset) in the extending direction from the positions of the depressions 11c of the other one of said every two adjacent anode current collector tabs 11b; and

FIG. 11 is a schematic view showing a way of each step of a battery production method according to one embodiment.

### DESCRIPTION OF EMBODIMENTS

[Battery]

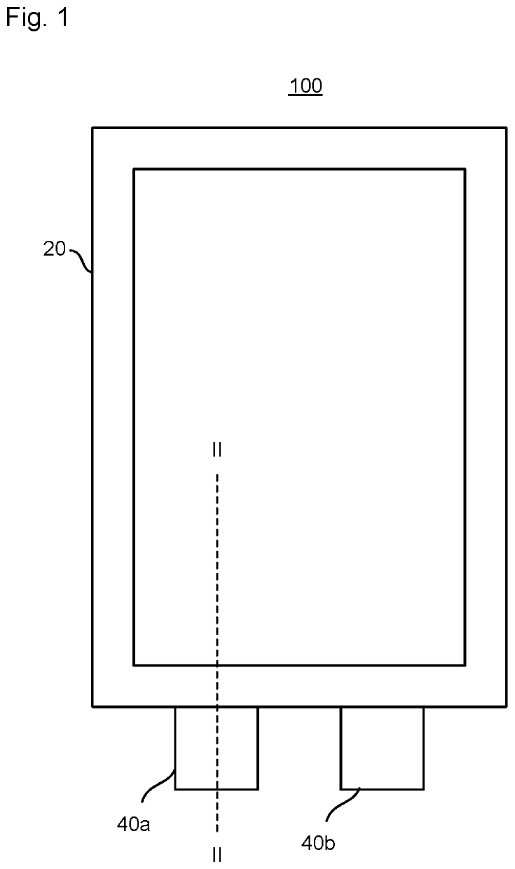

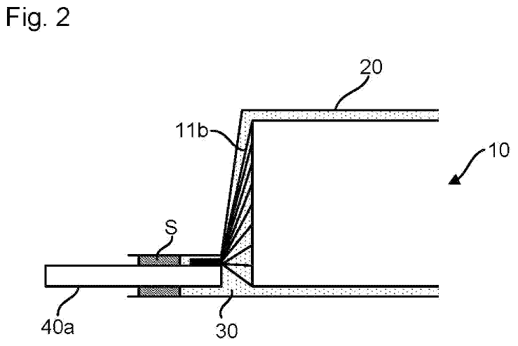

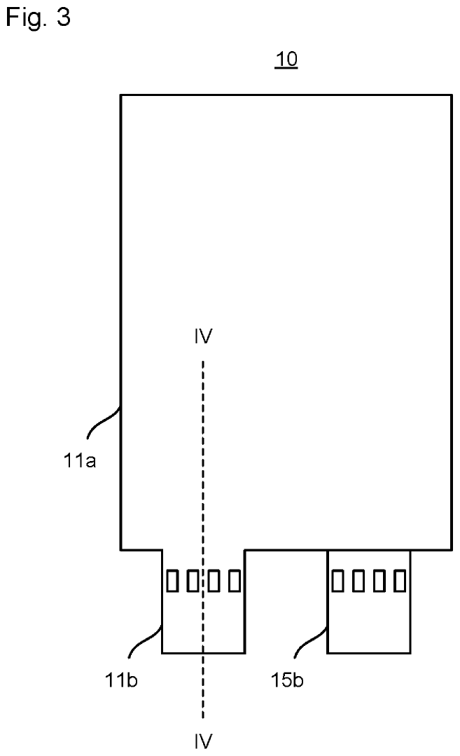

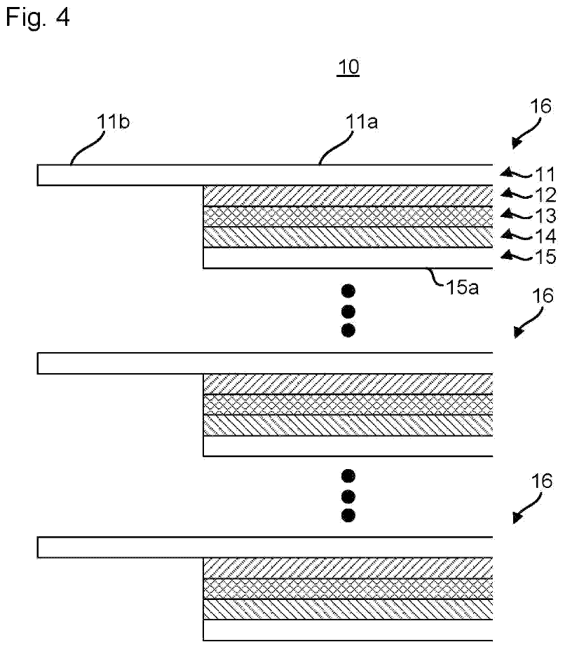

A battery according to the present disclosure will be described with reference to a battery 100 that is one embodiment. FIG. 1 is a plan view of the battery 100. FIG. 2 is a cross-sectional view taken along II-II of FIG. 1. FIG. 3 is a plan view of a power generating element 10. FIG. 4 is a cross-sectional view taken along IV-IV of FIG. 3.

The battery 100 is formed of an exterior body 20, the power generating element 10 housed in the exterior body 20, and a filler 30 placed between the power generating element 10 and the exterior body 20. The power generating element 10 has current collector tabs (an anode current collector tab 11b and a cathode current collector tab 15b) extending outward. The current collector tabs are connected to terminals (an anode terminal 40a and a cathode terminal 40b) for connecting to external members, respectively. In FIG. 3, the current collector tabs are placed on the same face of the power generating element 10, but are not limited to this. The current collector tabs may be placed on different faces of the power generating element 10. The positions where the terminals are placed are considered in the same manner as the current collector tabs.

<Power Generating Element 10>

The power generating element 10 is a power generating component for batteries. The power generating element 10 may be a stack formed by stacking electrodes, or a wound body formed by winding electrodes. The type of the power generating element 10 is not particularly limited. The power generating element 10 may be a power generating element for solution-based batteries, or for all-solid-state batteries. The shape of the power generating element 10 is not particularly limited. For example, the power generating element 10 may have a rectangular shape in a plan view. FIGS. 1 to 4 show, as an example, the battery 100 including the power generating element 10 that is a stack formed by stacking electrodes for all-solid-state batteries. The power generating element 10 that is a stack formed by stacking electrodes for all-solid-state batteries will be hereinafter described. It is noted that the structure of the power generating element 10 is not limited to the following.

The power generating element 10 is provided with an anode current collector layer 11, an anode active material layer 12, a solid electrolyte layer 13, a cathode active material layer 14, and a cathode current collector layer 15 in this order in the thickness direction. The power generating element 10 may be provided with plural electrode bodies 16 in the thickness direction: each of the electrode bodies 16 is one repeating unit including the anode current collector layer 11, the anode active material layer 12, the solid electrolyte layer 13, the cathode active material layer 14, and the cathode current collector layer 15. A plurality of the electrode bodies 16 may be stacked in series or in parallel. When the power generating element 10 is provided with a plurality of the electrode bodies 16, adjacent electrode bodies 16 may share the cathode current collector layer 11 or the anode current collector layer 15. FIG. 3 shows the power generating element 10 provided with a plurality of the electrode bodies 16.

(Anode Current Collector Layer 11)

The anode current collector layer 11 is made from metal foil in the form of a sheet. The anode current collector layer 11 is provided with an anode flat plate part 11a in contact with the anode active material layer 12, and the anode current collector tab 11b extending outward from the anode flat plate part 11a. The anode current collector tab 11b is a member for connecting the anode flat plate part 11a and the anode terminal 40a. The anode flat plate part 11a and the anode current collector tab 11b may be formed of one member, or of different members. When the power generating element 10 has a plurality of the electrode bodies 16, the anode current collector tabs 11b may be arranged so as to align straight in the thickness direction.

The anode current collector layer 11 may be formed from any metal without particular limitations. Examples of the metal here include Cu, Ni, Cr, Au, Pt, Ag, Al, Fe, Ti, Zn, Co, and stainless steel; and a preferred example thereof is Cu. The anode current collector layer 11 may have some coating (such as a carbon coating) on the surface thereof for adjusting the resistance. The anode current collector layer 11 may have a thickness of, for example, 0.1 μm to 1 mm.

(Anode Active Material Layer 12)

The anode active material layer is a layer in the form of a sheet, and containing an anode active material. The anode active material here is not particularly limited. Examples of this anode active material include silicon-based active materials such as Si, Si alloys, and silicon oxide; carbon-based active materials such as graphite and hard carbon; various oxide-based active materials such as lithium titanate; lithium metal; and lithium alloys.

The anode active material layer 12 may optionally contain a conductive additive, a binder, and/or a solid electrolyte. The conductive additive here is not particularly limited. Examples of this conductive additive include carbon materials such as acetylene black and Ketjenblack, and metallic materials such as nickel, aluminum, and stainless steel. The binder here is not particularly limited. Examples of this binder include butadiene rubber (BR), butyl rubber (IIR), acrylate-butadiene rubber (ABR), and polyvinylidene fluoride (PVdF). The solid electrolyte here is not particularly limited. For example, this solid electrolyte may be an organic polymer electrolyte or an inorganic solid electrolyte; and is preferably an inorganic solid electrolyte because the inorganic solid electrolyte has higher ion conductivity than, and superior heat resistance to the organic polymer electrolyte. The inorganic solid electrolyte here may be an oxide solid electrolyte or a sulfide solid electrolyte; and is preferably a sulfide solid electrolyte. Examples of the oxide solid electrolyte here include lithium lanthanum zirconate, LiPON, Li_{1+X}Al_{X}Ge_{2-X}(PO₄)₃, Li—SiO based glasses, and Li—Al—S—O based glasses. Examples of the sulfide solid electrolyte here include Li₂S—P₂S₅, Li₂S—SiS₂, LiI—Li₂S—SiS₂, LiI—Si₂S—P₂S₅, Li₂S—P₂S₅—LiI—LiBr, LiI—Li₂S—P₂S₅, LiI—Li₂S—P₂O₅, LiI—Li₃PO₄—P₂S₅, and Li₂S—P₂S₅—GeS₂.

The content of each component in the anode active material layer 12 may be appropriately set according to the purpose. The anode active material layer may have a thickness of, for example, 0.1 μm to 1 mm.

(Solid Electrolyte Layer 13)

The solid electrolyte layer 13 is a layer in the form of a sheet, and containing a solid electrolyte. The solid electrolyte here is not particularly limited. This solid electrolyte may be appropriately selected from the solid electrolytes that can be used for the anode active material layer.

The solid electrolyte layer 13 may optionally contain a binder. The binder here is not particularly limited. This binder may be appropriately selected from the binders that can be used for the anode active material layer.

The content of each component in the solid electrolyte layer 13 may be appropriately set according to the purpose. The solid electrolyte layer 13 may have a thickness of, for example, 0.1 μm to 1 mm.

(Cathode Active Material Layer 14)

The cathode active material layer 14 is a layer in the form of a sheet, and containing a cathode active material. The cathode active material here is not particularly limited. Examples of the cathode active material include various lithium-containing composite oxides such as lithium cobaltate, lithium nickelate, lithium manganate, lithium nickel cobalt oxide, lithium nickel cobalt manganese oxide, and spinel lithium compounds.

The cathode active material layer may optionally contain a conductive additive, a binder, and/or a solid electrolyte. The conductive additive, the binder, and the solid electrolyte here are not particularly limited. These conductive additive, binder, and solid electrolyte may be each appropriately selected from those usable for the anode active material layer.

The content of each component of the cathode active material layer 14 may be appropriately set according to the purpose. The surface of the cathode active material may be coated with an oxide layer such as a lithium niobate layer, a lithium titanate layer, and a lithium phosphate layer. The cathode active material layer may have a thickness of, for example, 0.1 μm to 1 mm.

(Cathode Current Collector Layer 15)

The cathode current collector layer 15 is made from metal foil in the form of a sheet. The cathode current collector layer 15 is provided with a cathode flat plate part 15a in contact with the cathode active material layer 14, and the cathode current collector tab 15b extending outward from the cathode flat plate part 15a. The cathode current collector tab 15b is a member for connecting the cathode flat plate part 15a and the cathode terminal 40b. The cathode flat plate part 15a and the cathode current collector tab 15b may be formed of one member, or of different members. When the power generating element 10 has a plurality of the electrode bodies 16, the cathode current collector tabs 15b may be arranged so as to align straight in the thickness direction.

The cathode current collector layer 15 may be formed from any metal without particular limitations. Examples of the metal here include Cu, Ni, Cr, Au, Pt, Ag, Al, Fe, Ti, Zn, Co, and stainless steel; and a preferred example thereof is Al. The cathode current collector layer 15 may have some coating (such as a carbon coating) on the surface thereof for adjusting the resistance. The cathode current collector layer 15 may have a thickness of, for example, 0.1 μm to 1 mm.

(Form of Depression)

The current collector tab(s) of the battery 100 comprise(s) a predetermined depression. The depression will be hereinafter described particularly in terms of the anode current collector tab 11b. This depression may be also arranged on the cathode current collector tab 15b. Thus, the following description can be also applied to the depression on the cathode current collector tab 15b.

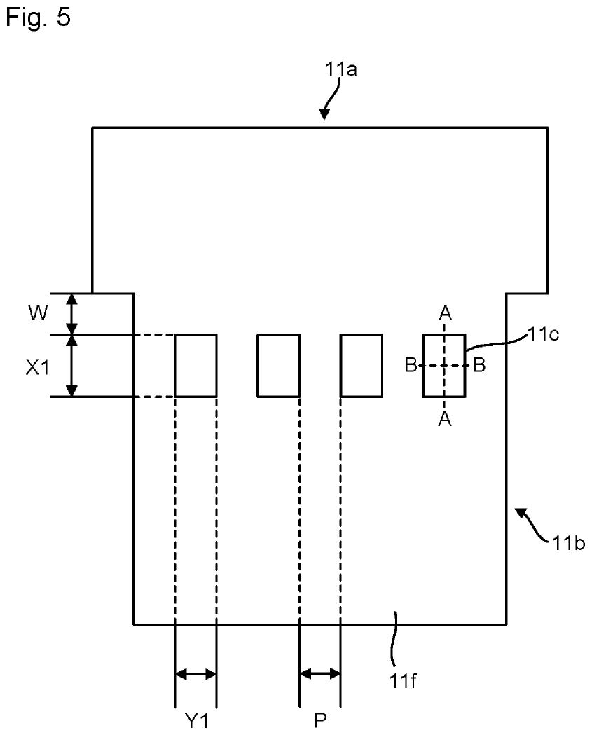

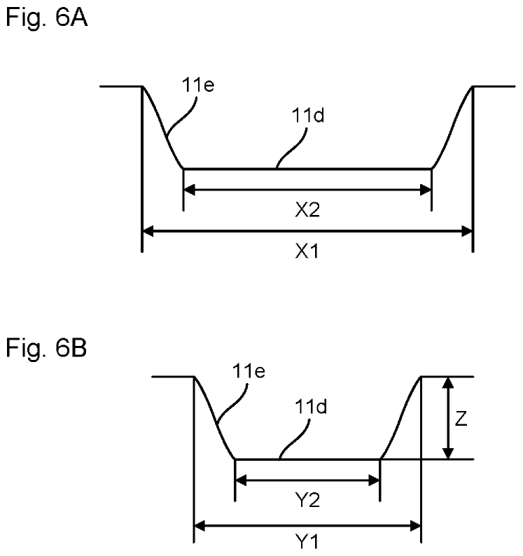

FIG. 5 is a plan view particularly focusing on the anode current collector tab 11b of the anode current collector layer 11. FIG. 6A is a cross-sectional view taken along A-A of FIG. 5; and FIG. 6B is a cross-sectional view taken along B-B of FIG. 5. Here, the up-down direction in FIG. 5 is defined as an extending direction (direction in which the anode current collection tab 11b extends), and the right-left direction in FIG. 5 is defined as a width direction (width direction of the anode current collection tab 11b).

As shown in FIG. 5, the anode current collector tab 11b is provided with depressions 11c. As shown in FIGS. 6A and 6B, each of the depressions 11c is formed of a bottom 11d, and a side wall 11e arranged vertically from the periphery of the bottom. The bottom 11d is the deepest portion of the depression 11c. As shown in FIGS. 6A and 6B, when the depression 11c has a rectangular cross-sectional shape, a side of the rectangle which forms the deepest portion is the bottom. When the depression has a polygonal cross-sectional shape such as a triangular shape, or a round cross-sectional shape such as a circular or elliptical shape, the deepest portion (point) of the cross-sectional shape is the bottom. A portion of the anode current collector tab 11b except the depressions 11c is defined as a plane part 11f.

The rigidity of the anode current collector tab 11b is improved because the anode current collector tab 11b is provided with the depressions 11c. At least part of each of the depressions 11c is positioned on an inner side of the anode current collector tab 11b (closer to the anode flat plate part 11a) than the center of the length of the anode current collector tab 11b in the extending direction. This can improve the rigidity of a portion of the anode current collector tab 11b on the anode flat plate part 11a side (root portion). In view of securing the areas for joining the anode current collector tab 11b and the electrode terminal 40b to each other, the entire depressions 11c may be positioned on an inner side of the anode current collector tab 11b than the center of the length of the anode current collector tab 11b in the extending direction. When the filler 30 is poured, a short circuit easily occurs due to deformation of the root portion of the anode current collector tab 11b. Thus, suppression of the deformation of the root portion further enhances a short circuit suppression effect.

The number of the depressions 11c of the anode current collector tab 11b is not particularly limited. This number may be at least one. In view of improving the rigidity of the root portion of the anode current collector tab 11b, a plurality of the depressions 11c may be provided as shown in FIG. 5. Any modes of positioning the depressions 11c are also permitted without particular limitations. Preferably, the depressions 11c are positioned to align in the width direction as shown in FIG. 5.

The outer shape of the depression 11c is not particularly limited. The depression 11c may have a rectangular, a polygonal, a circular, or an elliptic outer shape in a plan view (when viewed in the thickness direction). FIG. 5 shows the depressions 11c each having a rectangular shape in a plan view. The cross-sectional shape of the depression 11c is not particularly limited. FIGS. 6A and 6B each show the depression 11c having a rectangular cross-sectional shape.

The length X1 of the depression 11c in the extending direction is not particularly limited. For example, the length X1 may be at least 3 mm or at least 5 mm; and may be at most 10 mm, or at most 8 mm. The length Y1 of the depression 11c in the width direction is not particularly limited. For example, the length Y1 may be at least 2 mm or at least 4 mm; and may be at most 10 mm, or at most 8 mm. The aspect ratio of the depression 11c (the length X1 in the extending direction/the length Y1 in the width direction) is not particularly limited. The aspect ratio may be at least 0.5, at least 1, or at least 2; and may be at most 5, or at most 3. The length W between the anode flat plate part 11a and an end of the depression 11c in the extending direction on the inner side of the anode current collector tab 11b is not particularly limited. The shorter the length W is, the more the strength of the root portion improves. Too short a length W may lead to cracking, slips, etc. of the anode active material layer 12 when the depressions 11c are added. Therefore, the length W may be at least 0.5 mm or at least 1 mm; and may be at most 5 mm, or at most 3 mm. Each interval P between the depressions 11c is not particularly limited. The interval P may be at least 5 mm, or at least 8 mm; and at most 15 mm, or at most 12 mm.

Here, the length of the depression 11c in the extending direction is a length of a component of the depression 11c in the extending direction which is between a point of the depression 11c on the innermost side of the anode current collector tab 11b and a point thereof on the outermost side of the anode current collector tab 11b. The length of the depression 11c in the width direction is a length of a component of the depression 11c in the width direction which is between a point of the depression 11c on the side closest to one side of the anode current collector tab 11b in the width direction and a point thereof on the side closest to the other side of the anode current collector tab 11b in the width direction.

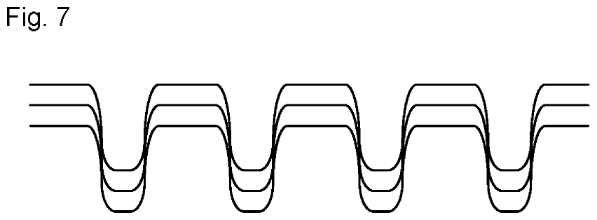

The depth Z of the depression 11c is not particularly limited. When the power generating element 10 is formed of one electrode body 16, the depth Z may be at most the thickness of the electrode body 16. When the power generating element is formed of a plurality of the electrode bodies 16, the depth Z may be at most a length between every two adjacent anode current collector tab 11b. Specifically, the depth Z of the depression 11e may be at least 0.1 μm, and at most 5 mm. In the mode shown in FIG. 7, and described below, the depth Z can be at least a length between every two adjacent anode current collector tab 11b in the thickness direction.

The size of the bottom 11d of the depression 11c is not particularly limited. The length X2 of the bottom 11d in the extending direction may be, for example, at least 0.5 times, or at least 0.7 times as long as the length X1 of the depression 11c in the extending direction; and at most 1 time, or at most 0.9 times as long as the length X1. The length Y2 of the bottom 11d in the width direction may be, for example, at least 0.5 times or at least 0.7 times as long as the length Y1 of the depression 11c in the width direction, and at most 1 time or at most 0.9 times as long as the length Y1. The cross-sectional shape of the side wall 11e of the depression 11c is not particularly limited. The side wall 11e may have a linear or tapered cross-sectional shape.

Next, the mode of stacking the depressions 11c will be described. When the power generating element 10 is provided with a plurality of the electrode bodies 16, the anode current collector tabs 11b are arranged to align in the thickness direction. In such a case, the positions of the depressions 11c of one of every two adjacent anode current collector tabs 11b in the thickness direction may be the same as or different from the positions of the depressions 11c of the other one of said every two adjacent anode current collector tabs 11b. Both the stacking modes each cause the depressions 11c of one of every two adjacent anode current collector tabs 11b to be in contact with the other one of said every two adjacent anode current collector tabs 11b even when the anode current collector tab(s) 11b deform(s) while the filler 30 is poured; thereby, the length between every two adjacent anode current collector tabs 11b can be kept fixed to suppress a short circuit that is caused by the contact of the anode current collector tab(s) 11b with the cathode active material layer(s) 14 or the cathode current collector layer(s) 15. It is also an advantage of either stacking mode that the filler easily penetrates through in production since the length between every two adjacent anode current collector tabs 11b can be kept fixed. A preferred stacking mode is that the positions of the depressions 11c of one of every two adjacent anode current collector tabs 11b in the thickness direction are different from the positions of the depressions 11c of the other one of said every two adjacent anode current collector tabs 11b. Here, the positions of the depressions 11c are the positions of the depressions 11c identified in the extending direction and in the width direction, that is, the positions of the depressions 11c in the planar direction of the anode current collector tabs 11b.

The stacking mode in such a way that the positions of the depressions 11c of one of every two adjacent anode current collector tabs 11b in the thickness direction are the same as the positions of the depressions 11c of the other one of said every two adjacent anode current collector tabs 11b encompasses a stacking mode in such a way that the bottoms 11d of the depressions 11c of one of every two adjacent anode current collector tabs 11b are each entirely included inside the depressions 11c of the other one of said every two adjacent anode current collector tabs 11b when viewed in the thickness direction, in addition to a stacking mode in such a way that the depressions 11c of one of every two adjacent anode current collector tabs 11b completely overlap the depressions 11c of the other one of said every two adjacent anode current collector tabs 11b when viewed in the thickness direction.

FIG. 7 shows one example of a stacking mode in such a way that the positions of the depressions 11c of one of every two adjacent anode current collector tabs 11b in the thickness direction are the same as the positions of the depressions 11c of the other one of said every two adjacent anode current collector tabs 11b.

FIG. 7 is a cross-sectional view of a stacking mode across the width of three anode current collector tabs 11b arranged to align in the thickness direction and each provided with a plurality of the depressions 11c aligning in the width direction: the stacking mode is in such a way that the bottoms 11d of the depressions 11c of one of every two adjacent anode current collector tabs 11b are each entirely included inside the depressions 11c of the other one of said every two adjacent anode current collector tabs 11b. As shown in FIG. 7, the bottoms 11d of the depressions 11c of one of every two adjacent anode current collector tabs 11b in the thickness direction each enter the depressions 11c of the other one of said every two adjacent anode current collector tabs 11b, so that the side walls 11e of the depressions 11c of the one adjacent anode current collector tabs 11b come into contact with the side walls 11e of the other anode current collector tab 11b; thereby, the length between every two adjacent anode current collector tabs 11b in the thickness direction can be kept fixed. Such a stacking mode allows the depth Z1 of the depressions 11c to be set in at least the length between every two adjacent anode current collector tabs 11b. This may cause any two adjacent anode current collector tabs 11b in the thickness direction to come into contact with each other even when no anode current collector tab 11 deforms. Thus, the effect of keeping the length between every two adjacent anode current collector tabs 11b fixed is enhanced.

The stacking mode in such a way that the positions of the depressions 11c of one of every two adjacent anode current collector tabs 11b in the thickness direction are different from the positions of the depressions 11c of the other one of said every two adjacent anode current collector tabs 11b encompasses: a stacking mode in such a way that the bottoms 11d of the depressions 11c of one of every two adjacent anode current collector tabs 11b are each partially included inside the depressions 11c of the other one of said every two adjacent anode current collector tabs 11b when viewed in the thickness direction; and a stacking mode in such a way that the bottoms 11d of the depressions 11c of one of every two adjacent anode current collector tabs 11b are each not entirely included inside the depressions 11c of the other one of said every two adjacent anode current collector tabs 11b, but the side walls 11e of the depressions 11c of said one anode current collector tab 11b are each at least partially included inside the depressions 11c of the other anode current collector tabs 11b, when viewed in the thickness direction; in addition to a stacking mode in such a way that the depressions 11c of one of every two adjacent anode current collector tabs 11b each do not completely overlap the depressions 11c of the other one of said every two adjacent anode current collector tabs 11b when viewed in the thickness direction.

These stacking modes are, in other words, stacking modes each in such a way that the bottoms 11d of the depressions 11c of one of every two adjacent anode current collector tabs 11b are at least partially included in the plane part 11f of another one of said every two adjacent anode current collector tabs 11b when viewed in the thickness direction. Such stacking modes each allow the bottoms 11d of the depressions 11c of one of every two adjacent anode current collector tabs 11b to be in contact with the plane part 11f of the other one of said every two adjacent anode current collector tabs 11b even when said one anode current collector tab 11b deforms; thus, can each keep the length between every two adjacent anode current collector tabs 11b fixed, and thereby, a short circuit caused by the contact of the anode current collector tab(s) 11b with the cathode active material layer(s) 14 or the cathode current collector layer(s) 15 can be suppressed. The following modes each allow this effect to be exerted more: the stacking mode in such a way that the depressions 11c of one of every two adjacent anode current collector tabs 11b do not completely overlap the depressions 11c of the other one of said every two adjacent anode current collector tabs 11b when viewed in the thickness direction; and the stacking mode in such a way that the bottoms 11d of the depressions 11c of one of every two adjacent anode current collector tabs 11b are each not entirely included inside the depressions 11c of the other one of said every two adjacent anode current collector tabs 11b, but the side walls 11e of the depressions 11c of said one anode current collector tab 11b are each at least partially included inside the depressions 11c of the other anode current collector tabs 11b, when viewed in the thickness direction. A stacking mode that allows the above-described effect to be further exerted is the mode in such a way that the depressions 11c of one of every two adjacent anode current collector tabs 11b each do not completely overlap the depressions 11c of the other one of said every two adjacent anode current collector tabs 11b when viewed in the thickness direction.

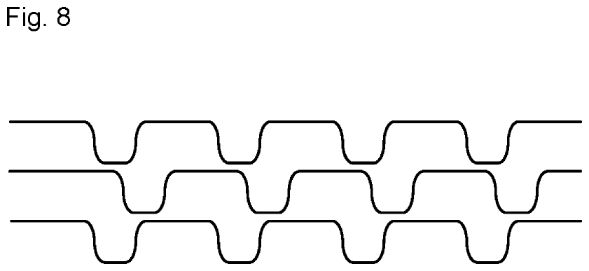

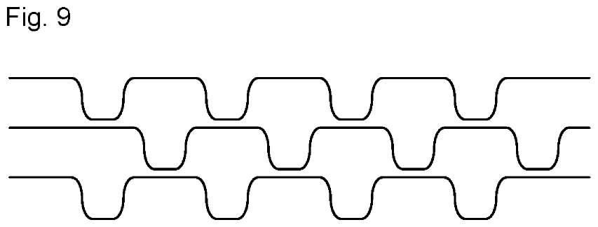

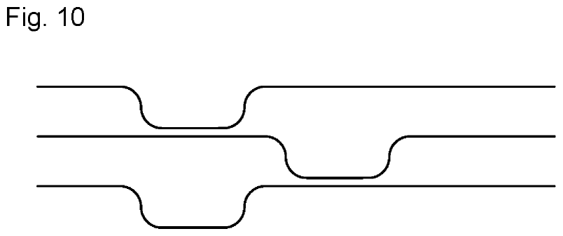

FIGS. 8 to 10 each show one example of a stacking mode in such a way that the positions of the depressions 11c of one of every two adjacent anode current collector tabs 11b in the thickness direction are different from the positions of the depressions 11c of the other one of said every two adjacent anode current collector tabs 11b. FIGS. 8 and 9 are each a cross-sectional view of a stacking mode across the width of three anode current collector tabs 11b arranged to align in the thickness direction and each provided with a plurality of the depressions 11c aligning in the width direction: the stacking mode is in such a way that the positions of the depressions 11c of one of every two adjacent anode current collector tabs 11b are apart (offset) in the width direction from the positions of the depressions 11c of the other one of said every two adjacent anode current collector tabs 11b. FIG. 10 is a cross-sectional view of a stacking mode across the width of three anode current collector tabs 11b arranged to align in the thickness direction and each provided with a plurality of the depressions 11c aligning in the width direction: the stacking mode is in such a way that the positions of the depressions 11c of one of every two adjacent anode current collector tabs 11b are apart (offset) in the extending direction from the positions of the depressions 11c of the other one of said every two adjacent anode current collector tabs 11b.

The mode shown in FIG. 8 is a stacking mode in such a way that the bottoms 11d of the depressions 11c of one of every two adjacent anode current collector tabs 11b are each partially included inside the depressions 11c of the other one of said every two adjacent anode current collector tabs 11b when viewed in the thickness direction. Therefore, when viewed in the thickness direction, the rests of the bottoms 11d of the depressions 11c of the one anode current collector tab 11b are included in the plane part 11f, which is except the depressions 11c of the other anode current collector tab 11b. The more the rests of the bottoms 11d of the depressions 11c of one of every two adjacent anode current collector tabs 11b are included in the plane part 11f, which is except the depressions 11c of the other one of said every two adjacent anode current collector tabs 11b, the more the above-described effect is enhanced. Specifically, preferably at least 50%, and more preferably at least 80% of the area of each of the bottoms 11d of the depressions 11c of one of every two adjacent anode current collector tabs 11b are included in the plane part 11f, which is except the depressions 11c of the other one of said every two adjacent anode current collector tabs 11b.

FIG. 9 shows a stacking mode in such a way that no depressions 11c of one of every two adjacent anode current collector tabs 11b overlap the depressions 11c of the other one of every two adjacent anode current collector tabs 11b when viewed in the thickness direction. Such a stacking mode enables the above-described effect to be obtained the most since the bottoms 11d of the depressions 11c of one of every two adjacent anode current collector tabs 11b are entirely included in the plane part 11f of the other one of every two adjacent anode current collector tabs 11b when viewed in the thickness direction.

FIG. 10 shows a stacking mode in such a way that no depressions 11c of one of every two adjacent anode current collector tabs 11b overlap the depressions 11c of the other one of every two adjacent anode current collector tabs 11b when viewed in the thickness direction. The mode of FIG. 10 is different from that of FIG. 9 in that the positions of the depressions 11c of one of every two adjacent anode current collector tabs 11b are apart (offset) in the extending direction from the positions of the depressions 11c of the other one of said every two adjacent anode current collector tabs 11b. Like this, the positions of the depressions 11c of one of every two adjacent anode current collector tabs 11b may be apart from the positions of the other one of every two adjacent anode current collector tabs 11b in the width or extending direction.

Such current collector tabs can be produced by, for example, adding the depressions by embossing. When the power generating element 10 is the stack, the depressions may be added to the current collector tabs before or after the stacking. When the power generating element 10 is the wound body, the depressions may be added to the current collector tabs before the electrodes are wound.

<Exterior Body 20>

The exterior body 20 is a member for housing the power generating element 10 thereinside. Any known exterior body may be used for the exterior body 20 without particular limitations. Examples of the exterior body include a metal laminate such as an Al laminate, and a metal housing such as a metal can. The shape of the exterior body 20 is not particularly limited, either. The exterior body 20 may have a rectangular or a cylindrical shape. In the battery 100, two metal laminates are combined to be used as the exterior body 20. When the power generating element 10 is sealed in, a heat welding part S is formed around the exterior body 20 of the metal laminates.

<Filler 30>

The filler 30 is a resin placed between the power generating element 10 and the exterior body 20 for protecting the power generating element 10. It is sufficient that the filler 30 is at least partially placed between the power generating element 10 and the exterior body 20. In particular, preferably, the filler 30 is placed between a face of the power generating element 10 where the current collector tabs are arranged, and the exterior body 20. The filler 30 may be entirely placed between the power generating element 10 and the outer body 20 in view of protecting the entire power generating element 10.

The material of the filler 30 is not particularly limited as long as being a resin. A thermoplastic or thermosetting resin, an ultraviolet curable resin, or the like may be used as the material of the filler 30.

<Terminals>

The terminals are members for connecting the power generating element 10 and external members to each other. The anode terminal 40a is connected to the anode current collector tab 11b; and the cathode terminal 40b is connected to the cathode current collector tab 15b. The material of the terminals is not particularly limited, but may be appropriately selected from the metallic materials that can be used for the anode terminal 40a or the cathode terminal 40b. The method of joining the current collector tabs and the terminals to each other is not particularly limited. Examples of this method include laser welding, ultrasonic bonding, and soldering.

[Battery Production Method]

Next, a production method for the battery according to the present disclosure will be described. The production method for the battery according to the present disclosure is not particularly limited. The battery may be produced by a known method. Hereinafter one embodiment of the production method for the battery provided with the power generating element that is a stack formed by stacking electrodes for all solid-state batteries will be described.

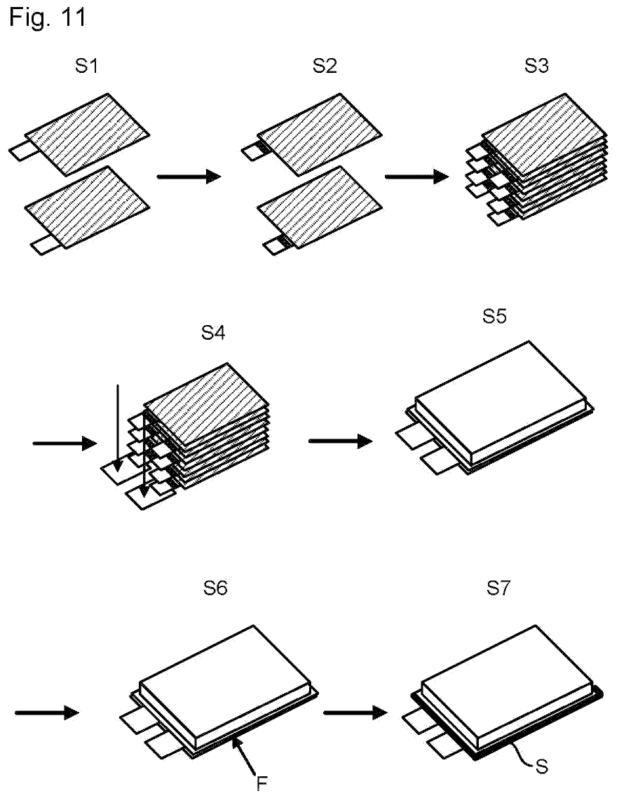

The battery production method according to one embodiment includes an electrodes preparation step S1, an embossing step S2, an electrodes stacking step S3, a terminals joining step S4, an exterior body housing step S5, a filler pouring step S6, and a sealing step S7. FIG. 11 is a schematic view of each of the steps.

<Electrodes Preparation Step S1>

The electrodes preparation step S1 is a step of preparing anode and cathode electrodes. The anode and cathode electrodes can be prepared by a known method. For example, the anode electrode can be obtained by: dispersing a material that is to constitute an anode active material layer in an organic solvent; and applying the obtained slurry to an anode current collector layer and drying the resultant. The cathode electrode can be obtained using the same method.

One may stack a solid electrolyte layer on either one of the anode and cathode electrodes to prepare the solid electrolyte layer, or may prepare the solid electrolyte layer separately from these electrodes. For example, one may stack the solid electrolyte layer on the anode electrode by dispersing a material that is to constitute the solid electrolyte layer in an organic solvent, applying the resultant to a surface of the anode active material layer of the anode electrode, and drying the resultant. Alternatively, one may prepare the solid electrolyte layer separately, and arrange the solid electrolyte layer between the cathode and anode electrodes in the electrodes stacking step S3.

Here, electrode layers may be formed on both the faces of the anode and cathode electrodes that are to be used inside the stack.

<Embossing Step S2>

The embossing step S2 is a step of adding the depressions to each current collector tab. A known method may be appropriately employed for the embossing.

<Electrodes Stacking Step S3>

The electrodes stacking step S3 is a step of stacking the anode and cathode electrodes to prepare the stack. The method of stacking each electrode is not particularly limited, but a known method can be appropriately employed. After the stack is prepared, the stack may be pressurized to enhance the adhesiveness of each electrode.

<Terminals Joining Step S4>

The terminals joining step S4 is a step of joining the current collector tabs and the terminals, respectively. The joining way is not particularly limited. Examples of the joining way include laser welding, ultrasonic bonding, and soldering.

<Exterior Body Housing Step S5>

The exterior body housing step S5 is a step of housing, in the external body, the power generating element to which the terminals are joined. In one embodiment, the power generating element is housed inside the exterior body that is formed by combining two metal laminates each provided with a protruded portion.

<Filler Pouring Step S6>

The filler pouring step S6 is a step of pouring a filler F into the inside of the exterior body, where the power generating element is housed. The way of pouring the filler is not particularly limited, but a known method can be appropriately employed. The rigidity of the current collector tabs is improved since predetermined depressions are formed on each current collector tab of the power generating element according to one embodiment. Therefore, even when the filler is poured, deformation of the current collector tabs is suppressed, and a short circuit that is caused by contact of the current collector tab(s) with the counter electrode is also suppressed.

<Sealing Step S7>

The sealing step S7 is a step of sealing the exterior body. The heat welding part S is formed around the periphery of the exterior body, so that the power generating element can be sealed in the inside of the exterior body since the metal laminates are used for the exterior body in one embodiment. When a metal housing is used for the exterior body, the exterior body can be sealed by, for example, laser welding.

### REFERENCE SIGNS LIST

10 power generating element
11 anode current collector layer
11a anode flat plate part
11b anode current collector tab
11c depression
11d bottom
11e side wall
11f plane part
12 anode active material layer
13 solid electrolyte layer
14 cathode active material layer
15 cathode current collector layer
15a cathode flat plate part
15b cathode current collector tab
16 electrode body
20 exterior body
30 filler
40a anode terminal
40b cathode terminal
100 battery

What is claimed is:

1. A battery comprising:
an external body;
a power generating element housed in the exterior body; and
a filler placed between the power generating element and the exterior body, wherein
the power generating element has a current collector tab extending outward, and
the current collector tab has at least one depression, at least part of the depression being positioned on an inner side of the current collector tab than a center of a length of the current collector tab in an extending direction.

2. The battery according to claim 1, wherein the current collector tab has a plurality of the depressions.

3. The battery according to claim 2, wherein the plurality of the depressions are arranged to align in a width direction of the current collector tab.

4. The battery according to claim 1, wherein
the power generating element has a plurality of the current collector tabs aligning in a thickness direction, and
a position of the depression of one of every adjacent two of the current collector tabs in the thickness direction is different from a position of the depression of another one of said every adjacent two.
